(19) United States
(12) Patent Application Publication
(10) Pub. No.: US 2016/0148421 A1
(43) Pub. Date: May 26, 2016

(54) Integrated Bird's Eye View with Situational Awareness

(71) Applicant: Caterpillar Inc., Peoria, IL (US)

(72) Inventor: Paul Russell Friend, Morton, IL (US)

(73) Assignee: Caterpillar Inc., Peoria, IL (US)

(21) Appl. No.: 14/552,008

(22) Filed: Nov. 24, 2014

(51) Int. Cl. G06T 17/05; G06T 3/40

(52) U.S. Cl. CPC G06T 17/05; G06T 3/40

(57) ABSTRACT

A method of integrating a captured view with a mapped view of a mobile machine within a worksite is provided. The method may include generating the captured view based on image data received from one or more image capture devices installed on the mobile machine, generating the mapped view based on mapped data corresponding to the worksite received from one or more tracking devices, overlaying the mapped view onto the captured view, and scaling the mapped view to the captured view.

### TECHNICAL FIELD

The present disclosure relates generally to mobile machines, and more particularly, to integrated display systems and interface devices for mobile mining and construction machines.

### BACKGROUND

Machines such as, for example, trucks, dozers, motor graders, wheel loaders, wheel tractor scrapers, and other types of heavy equipment are used to perform a variety of tasks. Autonomously and semi-autonomously controlled machines are capable of operating with little or no human input by relying on information received from various machine systems. For example, based on machine movement input, terrain input, and/or machine operational input, a machine can be controlled to remotely and/or automatically complete a programmed task. On minesites, construction sites, or other worksites, a plurality of such machines may be operated either autonomously or by vehicle operators physically present inside the machines. To increase safety on such worksites, operators of mobile machines need to be constantly aware of the behaviors and locations of other machines operating around them and must be able to maintain safe operating distances therewith.

One available solution provides a display screen to the vehicle operator or driver which shows graphical representations of the relative locations of other vehicles and features within the surrounding environment as tracked by a Global Positioning System (GPS), Global Navigation Satellite System (GNSS), Pseudolite System, Inertial Navigation System or other similar systems, and/or as sensed through perception sensors, such as radio ranging devices, Light Detection and Ranging (LIDAR) sensors or other related systems. Another available solution provides a display screen to the vehicle operator or driver which shows direct video feeds from cameras installed on or around the vehicle and enables various views including a bird's eye view of the vehicle. German Patent No. DE 102012102771 (“Baier”), for example, discloses an optical display device and two representation types, including a first representation that is based on recorded image data and a second representation that is based on digital map data. However, Baier, as well as other conventionally available solutions have their limitations.

Although conventional display systems like in Baier may provide the vehicle operator or driver with a collection of helpful views to choose from, switching between the available views while operating the vehicle or machine can become cumbersome, especially in vehicles or machines which demand much more operator involvement, such as mobile mining machines, mobile construction machines, or the like. One workaround may be to display both views simultaneously using separate display screens. This would however add to the cost of implementation and clutter to the operator cab. Another workaround may be to simultaneously display two separate views within a single display screen. However, in order to fit two separate views into a single screen, the scale or size of the views must be substantially reduced, which would make the screens difficult to read.

In view of the foregoing disadvantages associated with conventional displays and interface systems for mobile machines, a need therefore exists for cost efficient solutions capable of integrating data collected from multiple sources into a simplified interface.

### SUMMARY OF THE DISCLOSURE

In one aspect of the present disclosure, a method of integrating a captured view with a mapped view of a mobile machine within a worksite is provided. The method may include generating the captured view based on image data received from one or more image capture devices installed on the mobile machine, generating the mapped view based on mapped data corresponding to the worksite received from one or more tracking devices, overlaying the mapped view onto the captured view, and scaling the mapped view to the captured view.

In another aspect of the present disclosure, a system for integrating a captured view with a mapped view of a mobile machine within a worksite is provided. The system may include one or more image capture devices configured to generate image data of areas surrounding the mobile machine, one or more tracking devices configured to generate mapped data corresponding to the worksite, and an interface device in communication with the image capture devices and the tracking devices. The interface device may be configured to generate the captured view based on the image data, generate the mapped view based on the mapped data, overlay the mapped view onto the captured view, and scale the mapped view to fit the captured view.

In yet another aspect of the present disclosure, an interface device for a mobile machine is provided. The interface device may include an input device, an output device, a memory configured to retrievably store one or more algorithms, and a controller in communication with each of the input device, the output device, and the memory. The controller, based on the one or more algorithms, may be configured to at least generate a captured view of areas surrounding the mobile machine, generate a mapped view of features within an associated worksite, overlay the mapped view onto the captured view, and scale the mapped view to the captured view.

### BRIEF DESCRIPTION OF THE DRAWINGS

FIG. 1 is a pictorial illustration of one exemplary worksite;

FIG. 2 is a pictorial illustration of a mobile machine having one exemplary integrated display system implemented therewith;

FIG. 3 is a diagrammatic illustration of one exemplary integrated display system that may be used in conjunction with a mobile machine;

FIG. 4 is pictorial illustration of exemplary captured, mapped and integrated views generated by an interface device of the present disclosure;

FIG. 5 is pictorial illustration of different zoom levels of one exemplary integrated view generated by an interface device of the present disclosure; and

FIG. 6 is a flowchart of one exemplary disclosed algorithm or method that may be used to configure a controller of the present disclosure to integrate captured and mapped views into a single display.

### DETAILED DESCRIPTION

Although the following sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent other than the language of the claims. To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

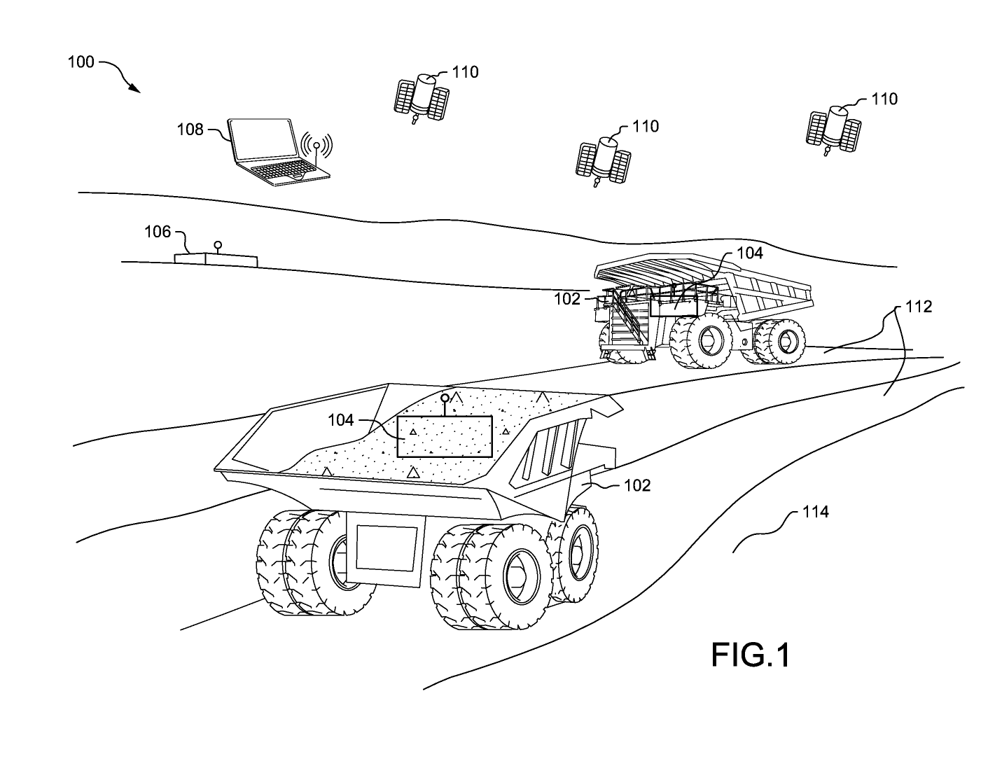

Referring now to FIG. 1, one exemplary worksite 100, such as a minesite, is illustrated with one or more mobile mining machines 102 configured to perform one or more predetermined tasks. The predetermined tasks of the machines 102 may include any one or more of a variety of tasks associated with mining or otherwise altering the geography at the minesite 100, such as bulk material removal operations, dozing operations, grading operations, leveling operations, and the like. A worksite may alternatively include, for example, a landfill, a quarry, a construction site, or the like. The machines 102 may alternatively be configured to perform operations associated with industries not related to mining, such as construction, farming, or the like. Moreover, the machines 102 may embody, for example, trucks, dozers, motor graders, wheel loaders, wheel tractor scrapers, or other types of autonomous or semi-autonomous machines not shown or disclosed herein.

The respective locations of the mobile machines 102 within the worksite 100 of FIG. 1 may be tracked by a network of tracking devices 104, which may be installed on one or more of the machines 102 within the worksite 100 and in communication with one another and/or with one or more associated command centers 106, computing devices 108, or the like. Moreover, the tracking devices 104 may communicate positioning data of the respective machines 102 using one or more satellites 110, such as via a Global Positioning System (GPS). The tracking devices 104 may alternatively employ a Global Navigation Satellite System (GNSS), a laser range finding system, or any other comparable means for tracking positioning information of the individual mobile machines 102 within the worksite 100. The tracking devices 104 may also receive location information pertaining to certain features within the worksite 100, such as pre-designated haul roads 112, avoidance zones 114, or any other predetermined geographical structure or area within the worksite 100.

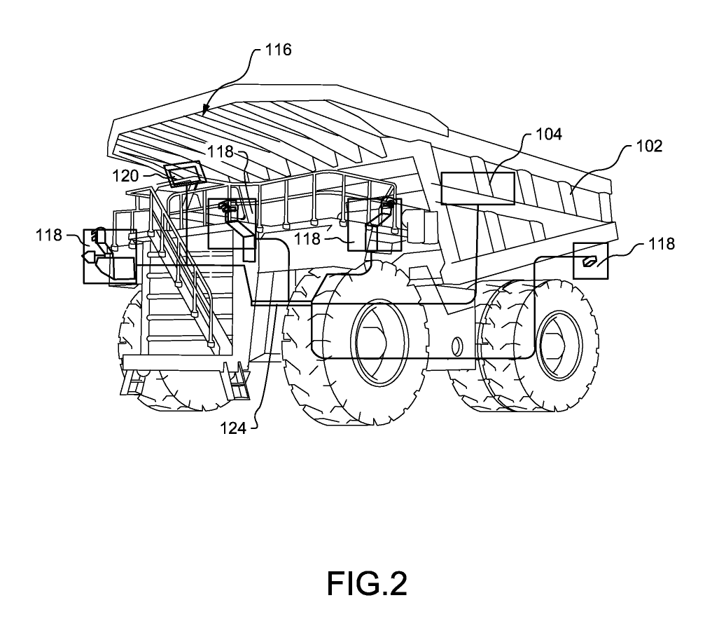

Turning to FIG. 2, one exemplary embodiment of an integrated display system 116 as implemented on a mobile machine 102 is provided. In general, the display system 116 may incorporate the tracking device 104 associated with the machine 102, as well as one or more image capture devices 118 and an interface device 120. The image capture devices 118 may be installed on the machine 102 in a manner which enables the display system 116 to observe substantially all sides of the machine 102, or to monitor views which collectively provide substantially 360-degree coverage of the surroundings of the machine 102. The image capture devices 118 may employ video cameras or any other comparable device suited to capture and provide live video feeds or other image data to the interface device 120. In the particular embodiment of FIG. 2, the display system 116 may employ four image capture devices 118, each positioned on a respective side of the machine 102 and configured to monitor the immediate area surrounding the machine 102. Other alternative configurations, such as having fewer or more image capture devices 118 and/or having different arrangements of image capture devices 118, may certainly be possible.

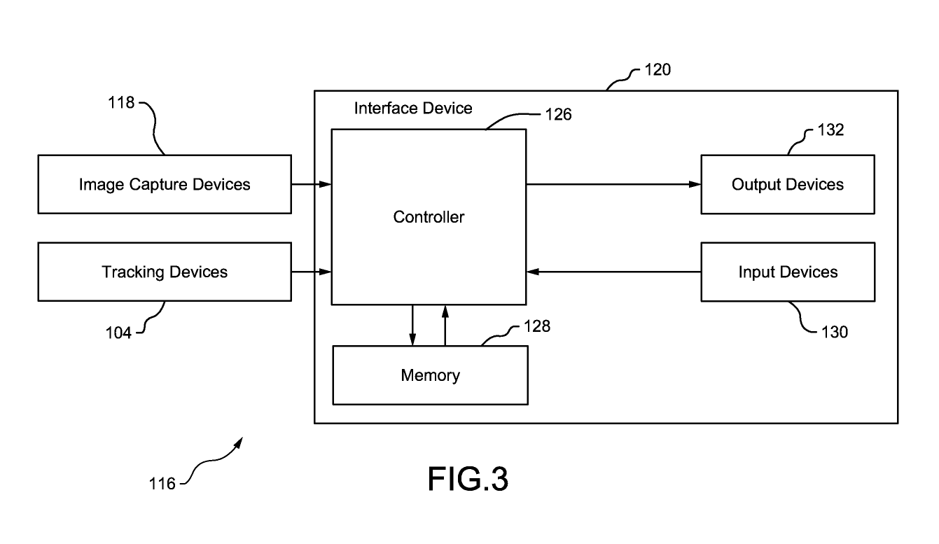

The interface device 120 of FIG. 2 may be installed within the operator cab 122 of the machine 102 and configured to electronically communicate with each of the tracking device 104 and the image capture devices 118 via a common bus 124 of the machine 102, or the like. As further shown in FIG. 3 for example, the interface device 120 may generally include a controller 126, a memory 128, an input device 130 and an output device 132. More specifically, the controller 126 may be in communication with each of the memory 128, input device 130 and output device 132, and configured to operate according to one or more algorithms that are retrievably stored within the memory 128. The memory 128 may be provided on-board the controller 126, external to the controller 126, or otherwise in communication therewith. The controller 126 may be implemented using any one or more of a processor, a microprocessor, a microcontroller, or any other suitable means for executing instructions stored within the memory 128. Additionally, the memory 128 may include non-transitory computer-readable medium or memory, such as a disc drive, flash drive, optical memory, read-only memory (ROM), or the like. The input device 130 may include touchscreens, touchpads, capacitive keys, buttons, dials, switches, or any other device capable of receiving input from the operator. The output device 132 may include a display screen or any other device configured to graphically display information to the operator.

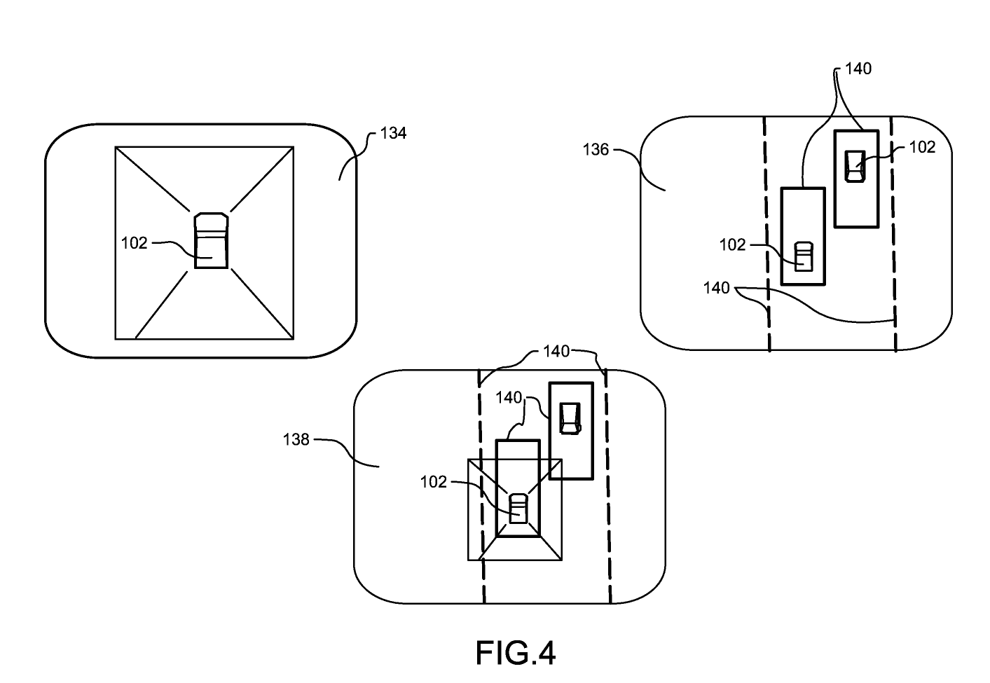

Furthermore, through the controller 126 of FIG. 3, the interface device 120 may be configured to communicate with one or more of the image capture devices 118 and the tracking devices 104, such as via the common bus 124 of FIG. 2. Through the bus 124, for example, the interface device 120 may receive image data generated by the image capture devices 118, as well as mapped data generated by the tracking device 104. The image data generated by the image capture devices 118 may correspond to video feeds of the surroundings of the machine 102. The mapped data generated by the tracking device 104 may include, for example, positioning data of other tracked mobile machines 102 within the worksite 100, or features within the worksite 100, such as pre-designated haul roads 112, avoidance zones 114, and the like. Based on the image data and the mapped data, the interface device 120 may be configured to generate at least two different types of views, such as a captured view 134 and a mapped view 136 as shown in FIG. 4 for example, and further overlay the two views 134, 136 together into a single integrated view 138 that is displayed via the output device 132 and made to be easily readable by the operator.

As shown in FIG. 4, the captured view 134 may be provided as a bird's eye view of the machine 102. More specifically, based on the image data received, the interface device 120 may be able to collect the videos individually captured by the image capture devices 118, and arrange the videos in a manner which simulates a bird's eye view of the machine 102. For example, if there are four cameras 118 installed on the machine 102, one on each of the four sides of the machine 102, each video captured by the cameras 118 may be displayed and positioned within the corresponding quadrant of the captured view 134 so as to provide the operator with a substantially 360-degree view of the surroundings of the machine 102. The mapped view 136 may also provide a bird's eye view, but unlike the direct video feeds of the captured view 134, the mapped view 136 may display graphical representations 140 of tracked features and/or other machines 102 that have been detected within the vicinity of the machine 102. Moreover, based on the mapped data received from the tracking devices 104, the interface device 120 may be configured to generate graphical representations 140 which outline the haul road 112 and other machines 102 as shown for example in FIG. 4. Alternative configurations of image capture devices 118 and tracking devices 104, as well as alternative captured and mapped views are also possible.

Still referring to FIG. 4, once the captured and mapped views 134, 136 are obtained, the interface device 120 may be configured to adjust the scale of, and if necessary the orientation of, the mapped view 136 to correspond to the captured view 134. For example, the mapped view 136 may be adjusted such that the relative size of objects outlined by graphical representations 140 therein substantially match the size of corresponding objects appearing within the captured view 134. Once appropriately scaled and adjusted, the interface device 120 may overlay the mapped view 136 onto the captured view 134 to provide the integrated view 138 shown in FIG. 4 for example. More particularly, outlines of the graphical representations 140 within the mapped view 136 may be superimposed onto the captured bird's eye view 134 such that the integrated view 138 provides the operator with two different modes of monitoring situational awareness within a single display of the screen or output device 132. Once the captured and mapped views 134, 136 are in substantial agreement, the interface device 120 may further lock the scale ratio and/or any other relationships between the captured and mapped views 134, 136 such that the integrated view 138 may be freely manipulated, without having to re-scale, re-size or otherwise adjust either of the captured and mapped views 134, 136 individually.

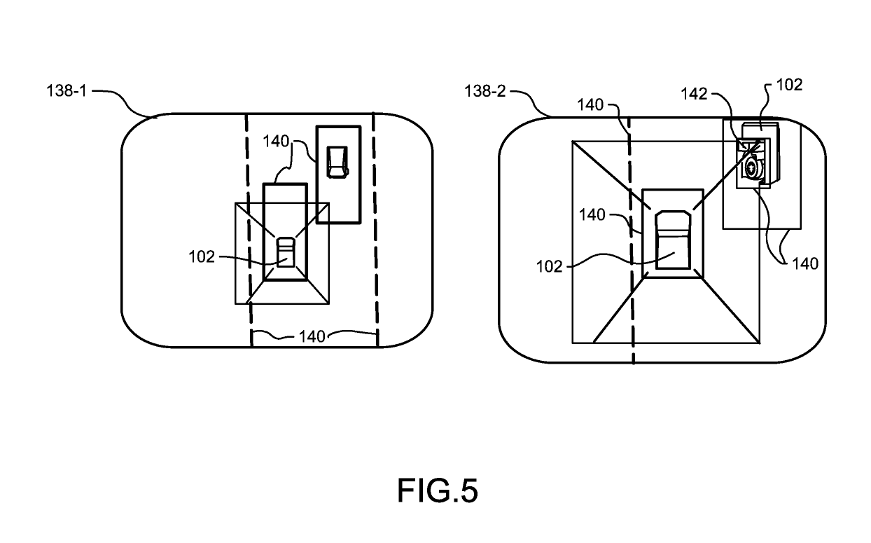

Additionally, the controller 126 of the interface device 120 may be configured to automatically adjust, such as scale, shift or translate, the integrated view 138 based on a detected travel speed or a direction of travel of the machine 102 as shown for example in FIG. 5. More specifically, the interface device 120 may be designed to automatically adjust the zoom level of the integrated view 138 so as to provide a zoomed-out view 138-1 at higher travel speeds and a zoomed-in view 138-2 at standstill or lower travel speeds, in a manner adapted to provide optimum situational awareness to the operator at all travel speeds. The interface device 120 may also automatically shift, translate or rotate the integrated view 138 according to the travel direction or orientation of the machine 102, such that the orientation or travel direction indicated on the integrated view 138 corresponds to the actual orientation or travel direction of the machine 102 relative to the worksite 100. The interface device 120 may obtain and/or derive the travel speed as well as the travel direction of the machine 102, for example, through the positioning information communicated via the mapped data and/or through direct measurements taken from within the machine 102. Furthermore, the travel speed may be compared against predefined thresholds to determine whether the zoom level should be adjusted. In addition, the zoom levels may range between a predefined minimum zoom level and a predefined maximum zoom level, and adjustments may be made gradually or in predefined increments between the minimum and maximum zoom levels.

Several alternative configurations, as well as optional and/or additional functions may also be implemented. In one alternative, the interface device 120 may overlay the captured view 134 onto the mapped view 136 and/or integrate additional views not shown herein. Furthermore, any one or more of the graphical representations 140 within the mapped view 136, such as other mobile machines 102 detected within the area, may be indexed using graphical identifiers 142, such as icon overlays, tags, labels, or the like. Moreover, the graphical identifiers 142 may be made visible within the integrated view 138. Optionally, any one or more of the captured view 134, mapped view 136, graphical representations 140 and the graphical identifiers 142 may be rendered to be at least partially transparent so as not to obstruct the operator's view of any underlying information. Still further, any one or more of the captured view 134, mapped view 136, graphical representations 140 and the graphical identifiers 142 may be toggled, or selectively disabled and enabled via operator input received through one or more of the input devices 130 of the interface device 120.

Other variations and modifications to the algorithms or methods employed to operate the integrated display systems 116, interface devices 120 and/or controllers 126 disclosed herein will be apparent to those of ordinary skill in the art. One exemplary algorithm or method by which the controller 126 of the interface device 120 may be operated, for instance to integrate a captured view 134 with a mapped view 136 of a mobile machine 102 within a worksite 100, is discussed in more detail below.

### INDUSTRIAL APPLICABILITY

In general terms, the present disclosure sets forth methods, devices and systems for mining, excavations, construction or other material moving operations where there are motivations to improve overall safety as well as productivity and efficiency. Although applicable to any type of machine, the present disclosure may be particularly applicable to autonomously or semi-autonomously controlled mobile mining machines, such as trucks, tractors, dozing machines, or the like, where multiple machines may be simultaneously controlled along shared and designated travel routes within the minesite. Moreover, the present disclosure may provide operators with a much more simplified means for monitoring situational awareness. In particular, by integrating different types of data collected from different modes of sources into a single interface, operators are able to control and navigate heavy machinery in a safer and more productive manner.

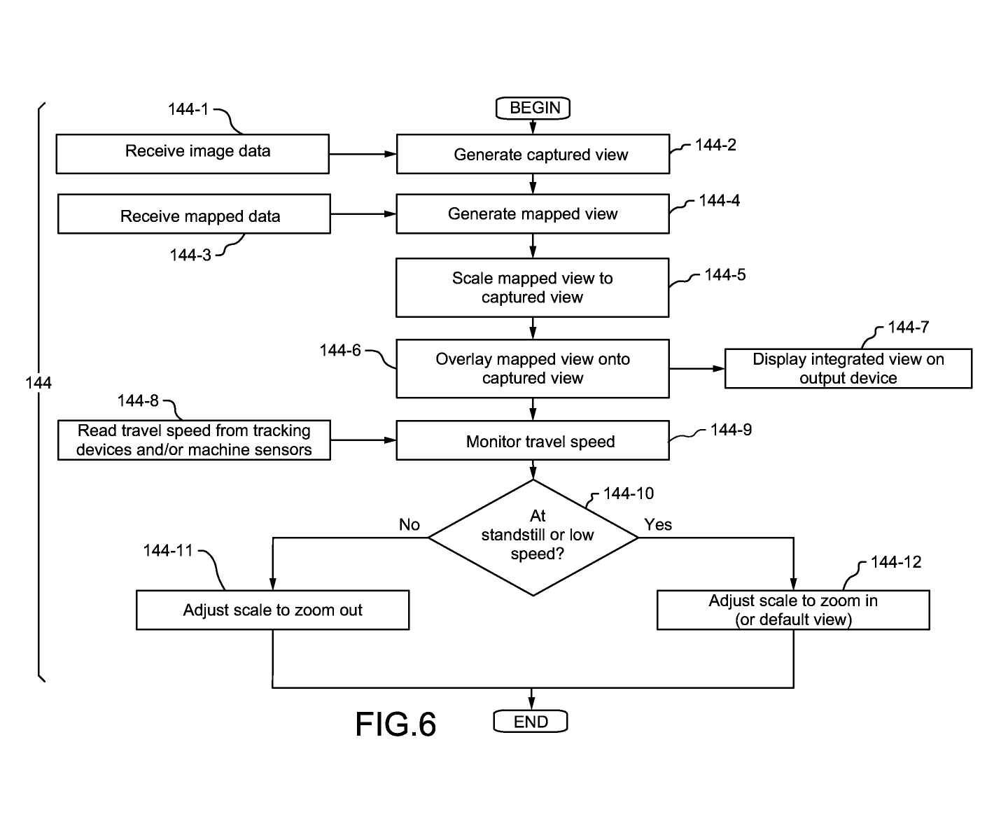

One exemplary algorithm or method 144 for integrating a captured view 134 with a mapped view 136 of a mobile mining machine 102 within a worksite 100, such as a minesite, is diagrammatically provided in FIG. 6, according to which, for example, the interface device 120, or the controller 126 thereof, may be configured to operate. As shown in block 144-1, the controller 126 may be configured to receive image data corresponding to live images or videos of the surroundings of the machine 102, as captured by one or more of the image capture devices 118 installed on the machine 102. In block 144-2, the controller 126 may generate a captured view 134, or bird's eye view, of the machine 102 by combining and appropriately arranging the image data received from the one or more image capture devices 118. In block 144-3, the controller 126 may be configured to simultaneously receive mapped data containing positioning data corresponding to features within the worksite 100 and/or other mobile machines 102 within the worksite 100, as tracked by one or more tracking devices 104. In block 144-4, the controller 126 may extract the relevant information from the mapped data to generate a mapped view 136 displaying, for example, graphical representations 140 of other mobile machines 102, pre-designated haul roads 112, avoidance zones 114, and the like, as well as any graphical identifiers 142 therefor.

In block 144-5 of FIG. 6, the controller 126 may be configured to scale the mapped view 136, and if necessary, adjust the orientation of the mapped view 136, to fit or correspond to the captured view 134. Once appropriate adjustments are made, the controller 126 in block 144-6 may overlay the mapped view 136 onto the captured view 134 to provide the integrated view 138 shown for example in FIG. 4. More particularly, outlines of the graphical representations 140 and any graphical identifiers 142 provided by the mapped view 136 may be superimposed onto the captured bird's eye view 134 such that the integrated view 138 provides the operator with two different modes of monitoring situational awareness within a single display of the output device 132. Correspondingly, the controller 126 in block 144-7 may be configured to display the resulting integrated view 138 to the operator via appropriate commands to the screen or output device 132 of the interface device 120. Additionally or optionally, the controller 126 may also monitor for any operator input, which may be received via the input devices 130 of the interface device 120, and which may be indicative of view preferences or other settings.

In further modifications, the method 144 of FIG. 6 may configure the controller 126 to adjust the integrated view 138 that is displayed on the output device 132 based on a travel speed as well as the travel direction of the machine 102. More specifically, the controller 126 in block 144-8 may communicate with the tracking device 104, so as to obtain or derive the current speed and the travel direction of the machine 102 via tracked positioning data, and/or communicate with sensors on-board the machine 102, so as to directly measure the travel speed and direction. In block 144-9, the controller 126 may monitor the current travel speed and direction, for example, in predefined intervals and/or in response to new speed data obtained in block 144-8, for as long as the interface device 120 is in use. In order to distinguish at least between relatively high and low speeds and determine the appropriate scale or zoom level, the controller 126 in block 144-10 may compare the travel speeds against preprogrammed thresholds. For example, if the machine 102 is traveling at relatively high speeds, the controller 126 in block 144-11 may adjust the scale of the integrated view 138 to zoom out and provide the operator with a broader perspective of the environment. If, however, the machine 102 is traveling at relatively low speeds or at standstill, the controller 126 in block 144-12 may adjust the scale of the integrated view 138 to zoom in and provide the operator with a narrower perspective of the environment.

In its simplest form, the method 144 in blocks 144-11 and 144-12 of FIG. 6 may configure the controller 126 to adjust the scale of the integrated view 138 according to preprogrammed zoom levels. However, in other modifications, the zoom levels may be dynamically increased or decreased according to predefined increments, progressively adjusted in proportion to the travel speed, or adjusted based on any other suitable technique. Furthermore, although the method 144 provided in FIG. 6 illustrates only one mode of classifying travel speed, it will be understood that other modes for detecting the travel speed and adjusting a zoom level based on the travel speed will be apparent to those of skill in the art and falls within the scope of the appended claims. For example, while block 144-10 may employ one preprogrammed threshold to distinguish between two classifications of travel speed, in alternative embodiments, the method 144 may employ more than one threshold to provide a more refined classification of the travel speed, and correspondingly, a more refined adjustment to the zoom level.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of integrating a captured view with a mapped view of a mobile mining machine within a minesite, comprising:
generating the captured view based on image data received from one or more image capture devices installed on the mobile mining machine;
generating the mapped view based on mapped data corresponding to the minesite received from one or more tracking devices;
overlaying the mapped view onto the captured view; and
scaling the mapped view to the captured view.

2. The method of claim 1, wherein the image data is received from one or more cameras installed on the mobile mining machine, and the captured view is a bird's eye view of the mobile mining machine that is generated by combining the image data provided by the one or more cameras.

3. The method of claim 1, wherein the mapped data includes tracked positioning data pertaining to the minesite and other mobile mining machines within the minesite, and the mapped view is generated to include graphical representations of the minesite and other mobile mining machines within the minesite.

4. The method of claim 1, wherein the mapped view includes graphical representations of at least haul roads, avoidance zones and other mobile mining machines.

5. The method of claim 1, wherein the mapped view is scaled to the captured view, and the captured view is further scaled according to a travel speed of the mobile mining machine.

6. The method of claim 1, wherein at least one of the captured view and the mapped view is at least partially transparent, the captured view and the mapped view being output to an interface device that is viewable by a machine operator.

7. The method of claim 1, wherein one or more features of the minesite and one or more mobile mining machines within the minesite are further distinguished using graphical identifiers.

8. A system for integrating a captured view with a mapped view of a mobile mining machine within a minesite, comprising:
one or more image capture devices configured to generate image data of areas surrounding the mobile mining machine;
one or more tracking devices configured to generate mapped data corresponding to the minesite; and
an interface device in communication with the image capture devices and the tracking devices, the interface device being configured to generate the captured view based on the image data, generate the mapped view based on the mapped data, overlay the mapped view onto the captured view, and scale the mapped view to fit the captured view.

9. The system of claim 8, wherein the image capture devices include one or more cameras installed on the mobile mining machine collectively configured to generate image data corresponding to a bird's eye view of the mobile mining machine.

10. The system of claim 8, wherein the tracking devices generate the mapped data to include at least tracked positioning data pertaining to the minesite and other mobile mining machines within the minesite, and the interface device generates the mapped view to include at least graphical representations of the minesite and other mobile mining machines within the minesite.

11. The system of claim 8, wherein the interface device is configured to generate the mapped view to include graphical representations of at least haul roads, avoidance zones and other mobile mining machines.

12. The system of claim 8, wherein the interface device is configured to scale the mapped view to the captured view, and further scale the captured view according to a travel speed of the mobile mining machine, the interface device being configured to derive the travel speed from the mapped data.

13. An interface device for a mobile mining machine, comprising:
an input device;
an output device;
a memory configured to retrievably store one or more algorithms; and
a controller in communication with each of the input device, the output device, and the memory and, based on the one or more algorithms, configured to at least generate a captured view of areas surrounding the mobile mining machine, generate a mapped view of features within an associated minesite, overlay the mapped view onto the captured view, and scale the mapped view to the captured view.

14. The interface device of claim 13, wherein the input device is configured to receive input from an operator of the mobile mining machine, and the output device includes at least a screen configured to display one or more of the captured view and the mapped view to the operator, the controller being configured to selectively output one or more of the captured view and the mapped view for display in response to the operator input received.

15. The interface device of claim 13, wherein the controller is in further communication with one or more cameras installed on the mobile mining machine, the controller being configured to generate a bird's eye view of the mobile mining machine based on image data received from the one or more cameras.

16. The interface device of claim 13, wherein the controller is in further communication with one or more tracking devices configured to track positioning data of the mobile mining machine, features within the minesite and other mobile mining machines within the minesite, the controller being configured to generate the mapped view based on the tracked positioning data.

17. The interface device of claim 13, wherein the controller is configured to generate the mapped view to include graphical representations of at least haul roads, avoidance zones and other mobile mining machines.

18. The interface device of claim 13, wherein the controller is configured to scale the mapped view to the captured view, and further scale the captured view according to a travel speed of the mobile mining machine, the controller being configured to derive the travel speed from the mapped data, and automatically adjust a zoom level of the captured view and the mapped view such that the output device zooms out as the travel speed increases and zooms in as the travel speed decreases.

19. The interface device of claim 13, wherein the controller is configured to render at least one of the captured view and the mapped view to be at least partially transparent when displayed on the output device.

20. The interface device of claim 13, wherein the controller is configured to distinguish one or more features of the minesite and one or more mobile mining machines within the minesite using graphical identifiers displayed on the output device.
